(19) United States
(12) Patent Application Publication
(10) Pub. No.: US 2014/0066073 A1
(43) Pub. Date: Mar. 6, 2014

(54) APPARATUS AND METHOD FOR HALTING COMMUNICATION NETWORK HANDOVER

(71) Applicant: Pantech Co., Ltd., Seoul (KR)

(72) Inventor: Yun Geun KWAG, Seoul (KR)

(73) Assignee: Pantech Co., Ltd., Seoul (KR)

(21) Appl. No.: 14/018,935

(22) Filed: Sep. 5, 2013

(30) Foreign Application Priority Data
Sep. 5, 2012 (KR) 10-2012-0098410

(51) Int. Cl. H04W 36/14

(52) U.S. Cl. CPC H04W 36/14
USPC 455/437

(57) ABSTRACT

In a method for halting a communication network handover of a mobile communication terminal connectable to a first communication network and a second communication network, differing from one another, and connecting preferentially to the first communication network, the mobile communication terminal is handed over from the first communication network to the second communication network based on a communication network handover instruction signal received from a mobile communication network. The mobile communication terminal detects a number of reception times of the communication network handover instruction signal, and halts the handover to the first communication network when the detected number of reception times exceeds a threshold.

### CROSS-REFERENCE TO RELATED APPLICATION

This application claims priority from and the benefit under 35 U.S.C. §119(a) of Korean Patent Application No. 10-2012-0098410, filed on Sep. 5, 2012, which is hereby incorporated by reference in its entirety for all purposes as if fully set forth herein.

### BACKGROUND

### Field

Exemplary embodiments of the present invention relate to an apparatus and method for preventing a communication network handover loop of a mobile communication terminal communicating through a plurality of communication networks.

### DISCUSSION OF THE BACKGROUND

A mobile communication terminal periodically notifies a mobile communication network, for example, a Long Term Evolution (LTE) network, about an electric field status in the mobile communication network. The mobile communication network receiving the data determines the electric field status of the mobile communication terminal, and forcibly hands over the mobile communication terminal to a different mobile communication network, for example, a Wideband Code Division Multiple Access (WCDMA) network, for smooth data communication when the mobile communication terminal is determined to be located in an area with a preset electric field or lower, hereinafter referred to as an area with a weak electric field, in the mobile communication network. In this example, the mobile communication network forcibly hands over the mobile communication terminal in the area with a weak electric field from the LTE network to the WCDMA network. The LTE network transmits a redirection instruction or a handover instruction to the mobile communication terminal in the area with the weak electric field, so that the mobile communication terminal is handed over to the WCDMA network.

An LTE mobile communication terminal may have a priority setting to be connected to an LTE network when both the LTE network and the WCDMA network are available for connection. Accordingly, the LTE mobile communication terminal may receive an LTE signal even in a weak electric field area, and thus connect to the LTE network. However, although the mobile communication terminal is connected to the LTE network, the LTE network continues to transmit a redirection instruction or a handover instruction to the mobile communication terminal as long as the mobile communication terminal is in the weak electric field area, so that the mobile communication terminal is handed over to the WCDMA network. That is, the LTE mobile communication terminal attempts to be connected to the LTE network, while the LTE communication network leads the mobile communication terminal to be connected to the WCDMA network. Such an iterative process ends when the mobile communication terminal moves and gets out of the weak electric field area or a cell of the LTE network is changed.

However, when the mobile communication terminal remains in the weak electric field area for a predetermined period of time, repeated alternation of connection to the LTE network and the WCDMA network continues, and a stable communication service may not be provided.

Further, a loop of connection to the LTE network and the WCDMA network causes excessive battery consumption. Also, the first communication network can be associated with a cost that is lower for a network carrier than a comparable cost associated with the second communication network. Moreover, the first communication network can be associated with a cost that is lower for a mobile communication user than a comparable cost associated with the second communication network.

### SUMMARY

Exemplary embodiments of the present invention provide a method for handing over communications of a mobile communication terminal according to an instruction that is received less than a threshold number of times.

Additional features of the invention will be set forth in the description that follows, and in part will be apparent from the description, or may be learned by practice of the invention.

An exemplary embodiment of the present invention discloses a method for controlling handover of a mobile communication terminal, the method including: communicating with a first communication network; receiving a communication network handover instruction to handover communications from the first communication network to a second communication network; communicating with the second communication network; detecting a number of reception times of the communication network handover instruction; and halting the handover from the second communication network to the first communication network when the detected number of reception times exceeds a threshold.

An exemplary embodiment of the present invention discloses a mobile communication terminal to control handover between networks, the terminal including: a transceiver configured to communicate with a first communication network and a second communication network; a reception unit configured to receive from the first communication network an communication network handover instruction to handover communications from the first communication network to the second communication network; a detection unit configured to detect a number of reception times of the communication network handover instruction; and a control unit configured to halt the handover from the second communication network to the first communication network, when the detected number of reception times exceeds a threshold and the terminal is communicating over the second communication network.

An exemplary embodiment of the present invention discloses a non-transitory readable storage that, when executed by an imaging apparatus including one or more processors, causes the one or more processors to hand over communications of a mobile communication terminal, the operations including: communicating with a first communication network; receiving a communication network handover instruction to handover communications from the first communication network to a second communication network; communicating with the second communication network; detecting a number of reception times of the communication network handover instruction; and halting the handover from the second communication network to the first communication network when the detected number of reception times exceeds a threshold.

It is to be understood that both the forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings. The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a configuration of an apparatus for halting a communication network handover according to exemplary embodiments of the present invention.

FIG. 2 is a flowchart illustrating a method for halting a communication network handover according to exemplary embodiments of the present invention.

FIG. 3 is a flowchart illustrating a method for halting the communication network handover according to exemplary embodiments of the present invention.

FIG. 4 is a flowchart illustrating a method of canceling an operation of halting a communication network handover according to exemplary embodiments of the present invention.

FIG. 5 illustrates changing a cell of a mobile communication network of a mobile communication terminal according to exemplary embodiments of the present invention.

FIG. 6 is a flowchart illustrating a method of canceling an operation of halting a communication network handover according to exemplary embodiments of the present invention.

FIG. 7 is a flowchart illustrating a method of canceling an operation of halting a communication network handover according to exemplary embodiments of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Descriptions of well-known functions and constructions may be omitted for increased clarity and conciseness.

It will be understood that when an element is referred to as being “connected to” another element, it can be directly connected to the other element, or intervening elements may be present.

An apparatus may hand over a mobile communication terminal in a particular communication network, for example, a Long Term Evolution (LTE) network, to a different communication network, for example, a Wideband Code Division Multiple Access (WCDMA) network, using a redirection or handover function in a mobile communication network when an electric field of the mobile communication terminal in the particular communication network, for example, an LTE network, falls to a preset threshold or lower.

An apparatus for halting a communication network handover may prevent a looping of a connection process of a mobile communication terminal. The looping occurs as the mobile communication terminal remains in an area with a weak electric field of a first communication network, for example, an LTE network, and detects a signal of the first communication network. The mobile communication terminal is connected to the first communication network even after being forcibly handed over by the first communication network to a second communication network, for example, from a LTE network to a WCDMA network, and then is again forcibly handed over by the first communication network back to the second communication network. By halting or preventing this loop, excessive consumption of a battery of the mobile communication terminal may be reduced, and a more stable communication service may be provided to the mobile communication terminal.

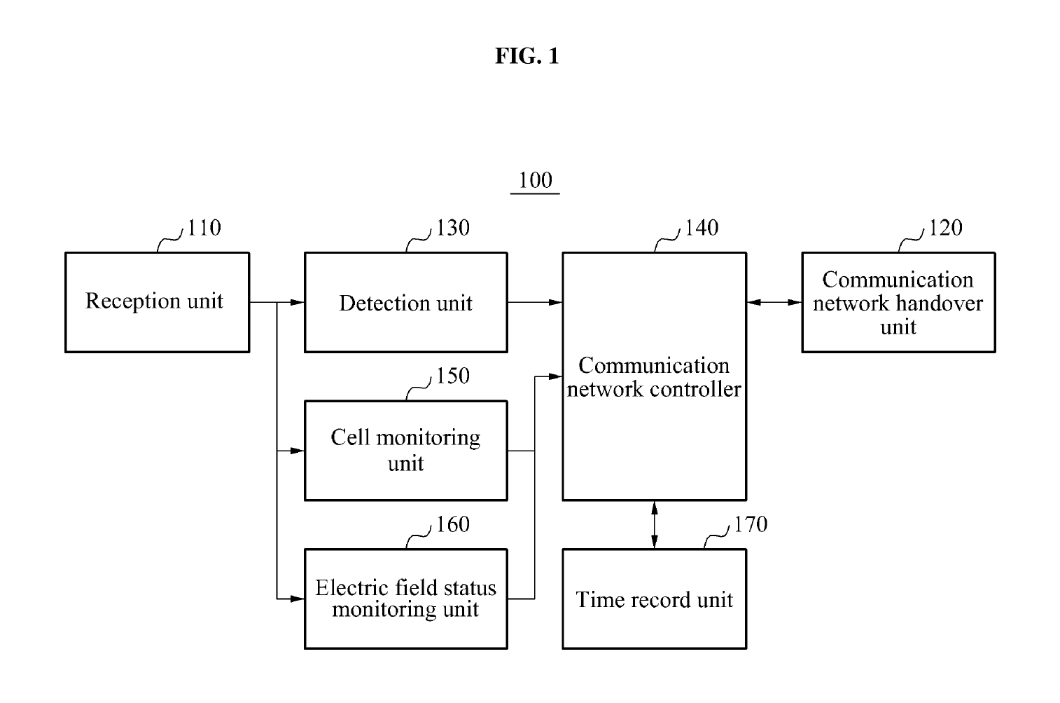

FIG. 1 is a block diagram illustrating a configuration of an apparatus for halting a communication network handover according to exemplary embodiments of the present invention.

An apparatus 100 for halting the communication network handover of a mobile communication terminal may be connected to different types of communication networks including a first communication network and a second communication network, and may be initially connected to the first communication network for the purpose of the following description.

Referring to FIG. 1, the apparatus 100 for halting the communication network handover may include a reception unit 110, a communication network handover unit 120, a detection unit 130, and a communication network controller 140. The apparatus 100 for halting the communication network handover may further include a cell monitoring unit 150, an electric field status monitoring unit 160, and a time record unit 170.

The reception unit 110 may receive a communication network handover instruction signal from a mobile communication network. The communication network handover unit 120 may hand over the mobile communication terminal from the first communication network to the second communication network, based on the received communication network handover instruction signal.

The reception unit 110 may be configured as a layer to which data is received through various communication schemes. For example, the reception unit 110 may include a Non-Access Stratum (NAS) responsible for communication with a core network in the mobile communication terminal, a Radio Resource Control (RRC) layer responsible for communication with an access network, and an L1/L2 layer responsible for physical communication with the mobile communication network.

The apparatus 100 for halting the communication network handover may include a handover detection unit (not shown) to detect a handover instruction as one of handover instruction signals transmitted from the mobile communication network and transmit the handover instruction to the communication network controller 140.

The apparatus 100 for halting the communication network handover may include a redirection detection unit (130) to detect a redirection instruction as one of handover instruction signals transmitted from the mobile communication network and transfer the redirection instruction to the communication network controller 140.

In some embodiments, the detection unit 130 may detect and count a number of times the communication network handover instruction signal was received. The communication network controller 140 may determine whether the detected number of reception times exceeds a preset number or threshold. The communication network controller 140 may control or prevent the mobile communication terminal from being handed over to the first communication network when the number of reception times exceeds the preset number. For example, the communication network controller 140 may control the mobile communication terminal to not conduct cell reselection with respect to the first communication network when the detected number of reception times exceeds the preset number.

Here, cell reselection refers to an operation of searching again for a cell having an electric field strength greater than a predetermined threshold. The searching allows the mobile communication terminal in an area having a weak electric field to be handed over from the second communication network to the first communication network. In exemplary embodiments, cell reselection may be conducted iteratively on a basis of a predetermined period.

The mobile communication terminal may remain in an area having a weak electric field of the first communication network. Thus, even though cell reselection is conducted and an electric field of a preferred first communication network is detected whose strength is less than or equal to a preset threshold, the mobile communication terminal may maintain connection to the second communication network by halting a handover back to the first communication network. Due to the presence of the weak electric field, the mobile communication terminal conducts cell reselection iteratively despite having a maintained connection to the second communication network. This can quickly consume the power in the mobile communication terminal. Thus, when the detected number of reception times of the communication network handover instruction signal received from the mobile communication network exceeds the preset number, the communication network controller 140 may prevent cell reselection, thereby preventing the cell reselection from being wastefully conducted.

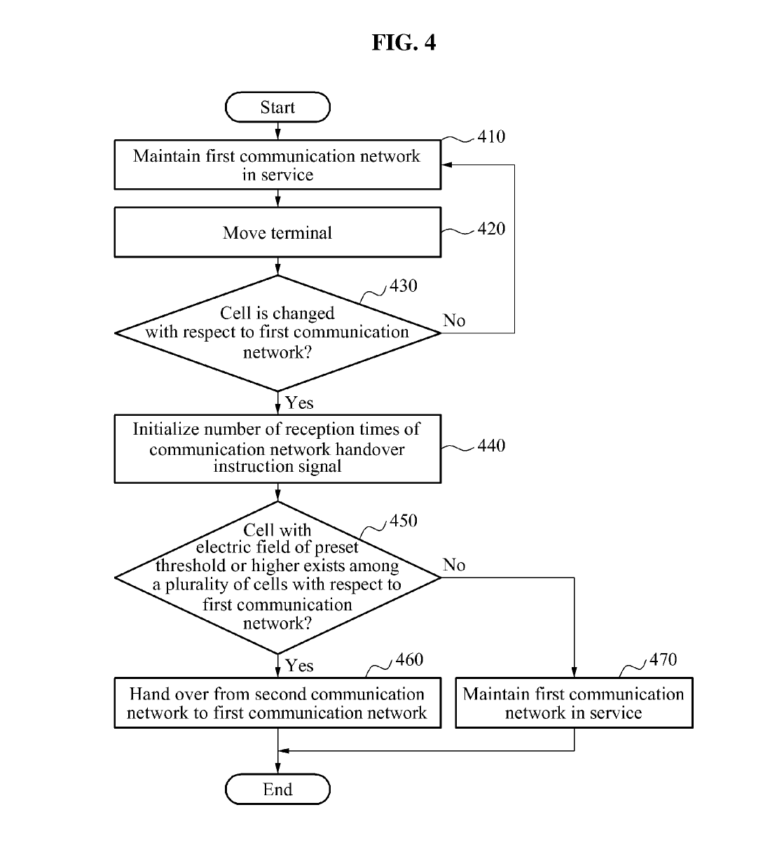

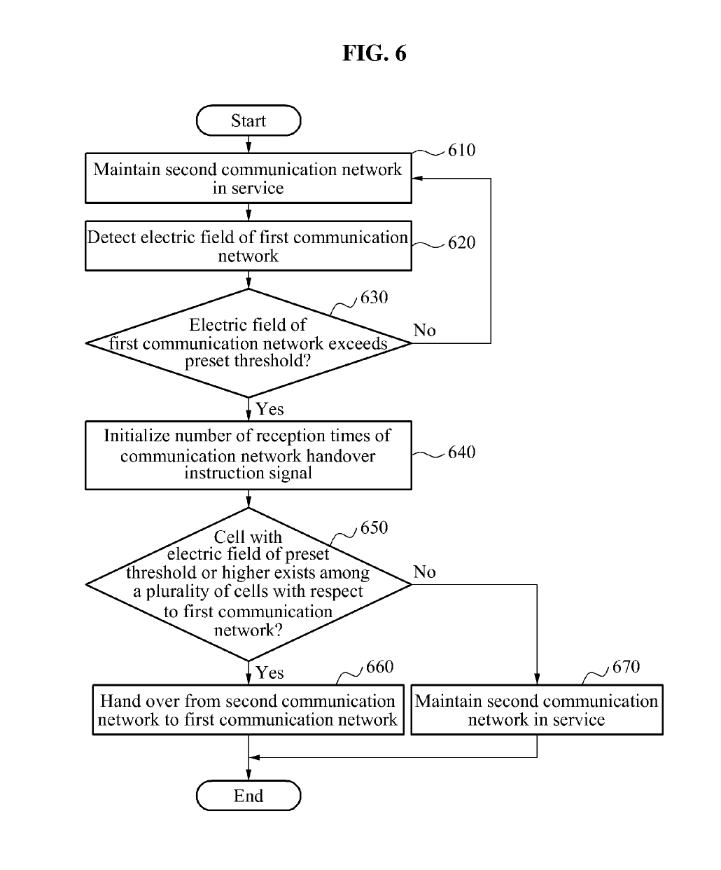

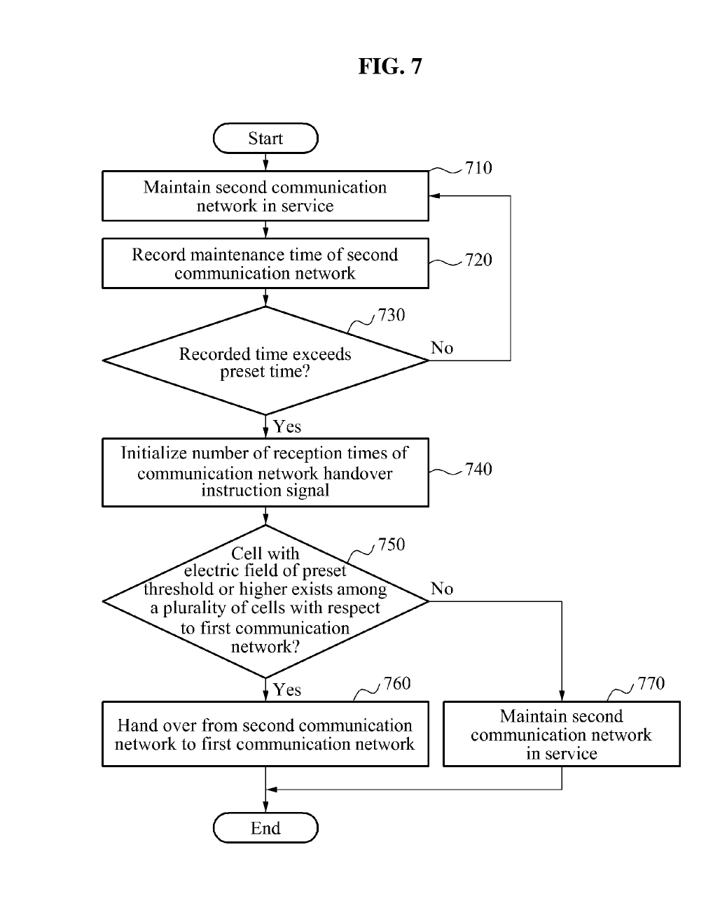

The communication network controller 140 may conduct cell reselection when the detected number of reception times of the communication network handover instruction signal received from the mobile communication network is lower than a threshold or preset number. As the mobile communication terminal may not move out of the area having the weak electric field within a preset time, the communication network controller 140 may conduct the cell reselection by comparing the number of reception times of the communication network handover instruction signal with a threshold for preventing cell reselection from being conducted, and then not conduct the cell reselection when the number of reception times exceeds the threshold. In some embodiments, the number of reception times can be initialized, for example, as illustrated in exemplary embodiments of FIG. 4, FIG. 6 and FIG. 7 discussed below.

The apparatus 100 for halting the communication network handover may provide a function of preventing a handover between various communication networks. Here, the first communication network may be an LTE network, the second communication network may be a WCDMA network, and the apparatus 100 for halting the communication network handover may control the hand over from the LTE network to the WCDMA network or from the WCDMA network back to the LTE network. More generally, the first communication network may be a kind of non-legacy communication network, while the second communication network may be a kind of legacy communication network.

According to exemplary embodiments of the present invention, the communication network controller 140 is not involved in a handover prevention process from the second communication network to the first communication network when a number of communication network handovers is a lower than a threshold or preset number. That is, when the mobile communication terminal has a connection signal of the first communication network, for example, the LTE network, in a state of being connected to the second communication network, for example, the WCDMA network, the mobile communication terminal is connected to the first communication network having a connection priority and the communication network controller 140 does not conduct a handover prevention process with respect to a handover to the first communication network. The handover prevention process is conducted to prevent iterative connection to a different network when the detected number of reception times of the communication network handover instruction signal exceeds the preset number.

As described above, the communication network controller 140 may control the mobile communication terminal to halt a hand over to the first communication network. Meanwhile, since the mobile communication terminal may be handed over back to the first communication network and be connected thereto depending on the mobile communication terminal's situation, the communication network controller 140 may control the mobile communication terminal to be handed over back to the first communication network when a preset condition is satisfied. Hereinafter, operations of the communication network controller 140 to control the mobile communication terminal to be handed over back to the first communication network according to various exemplary embodiments will be described in more detail.

The communication network controller 140 may retrieve electric fields of a plurality of cells with respect to the first communication network, and hand over to the first communication network when a cell, of which an electric field is higher than a predetermined threshold, is present among the plurality of cells with respect to the first communication network. For example, the communication network controller 140 may control the mobile communication terminal to conduct the cell reselection again.

For example, the communication network controller 140 may control the hand over back to the LTE network through the RRC layer of the LTE network of a cell where the mobile communication terminal is positioned in an area where an electric field exceeds a threshold through the cell reselection.

The apparatus 100 for halting the communication network handover may monitor whether a cell is changed with respect to the first communication network using the cell monitoring unit 150, and the communication network controller 140 may hand over to the first communication network when a cell is changed with respect to the first communication network. For example, the communication network controller 140 may control the mobile communication terminal to conduct the cell reselection again.

For example, when an LTE cell change occurs, the cell monitoring unit 150 may receive status information on the cell change from the L1/L2 layer and transfer the status information to the communication network controller 140. When an LTE cell is changed, the communication network controller 140 may control the mobile communication terminal to conduct the cell reselection again and thus to be handed over back to the LTE network through the RRC layer.

The apparatus 100 for halting the communication network handover may monitor an electric field with respect to the first communication network using the electric field status monitoring unit 160, and the communication network controller 140 may control the mobile communication terminal to be handed over to the first communication network when the electric field with respect to the first communication network exceeds the preset threshold. For example, the communication network controller 140 may control the mobile communication terminal to conduct the cell reselection again.

For example, when an LTE electric field is changed, the electric field status monitoring unit 160 may receive status information about the change of the electric field from the L1/L2 layer and transfer the status information to the communication network controller 140. The communication network controller 140 may control the mobile communication terminal to conduct cell reselection operation and thus to be handed over to the LTE network through the RRC layer when the electric field in the LTE cell is greater than a preset threshold.

The apparatus 100 for halting the communication network handover may use the time record unit 170 to record a duration in which hand over of the mobile communication terminal to the first communication network is prevented, and the communication network controller 140 may control the mobile communication terminal to be handed over to the first communication network when the recorded period of time exceeds the duration. After the duration elapses, the communication network controller 140 may control the mobile communication terminal to conduct the cell reselection again.

For example, when the recorded period of time exceeds a designated time or duration, the communication network controller 140 may control the mobile communication terminal to conduct the cell reselection again and thus to be handed over back to the LTE network through the RRC layer.

As described above, the apparatus 100 for halting the communication network handover may prevent a loop of a Radio Access Technology (RAT) process when the mobile communication terminal is positioned in an area with a weak electric field of the first communication network.

The apparatus 100 for halting the communication network handover may further include a location registration unit. The location registration unit may notify the mobile communication network of a status of the mobile communication terminal. The status can indicate when the mobile communication terminal is connected to the core network, a location of the mobile communication terminal is changed, or the mobile communication terminal is switched. For example, the apparatus 100 for halting the communication network handover may conduct a Routing Area Update (RAU) process when conducting a handover to the WCDMA network, conduct a Tracking Area Update (TAU) when conducting a handover to the LTE network, or be connected until a location registration process ends so as to transmit a location registration message to the mobile communication network.

In exemplary embodiments, the mobile communication terminal may transmit a status of the mobile communication terminal to the mobile communication network periodically or as an event trigger. For example, the mobile communication terminal may transfer information about an electric field of the mobile communication terminal to the mobile communication network.

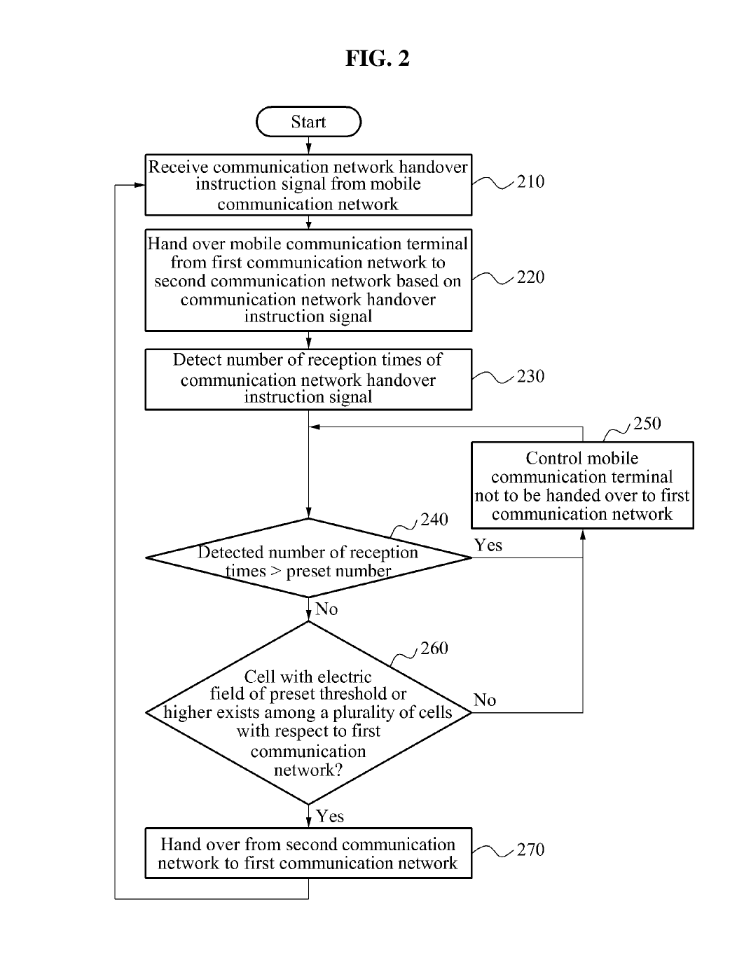

FIG. 2 is a flowchart illustrating a method for halting a communication network handover according to exemplary embodiments of the present invention.

In a method for halting the communication network handover, a mobile terminal may receive a communication network handover instruction signal from a mobile communication network in operation 210 and hand over a mobile communication terminal from the first communication network to the second communication network, based on the communication network handover instruction signal in operation 220 during typical operation.

The method for halting the communication network handover may detect a number of reception times of the communication network handover instruction signal in operation 230 and determine whether the detected number of reception times exceeds a preset number in operation 240. Here, when the detected number of reception times exceeds the preset number, the method for halting the communication network handover may control the mobile communication terminal not to be handed over to the first communication network in operation 250. For example, when the detected number of reception times exceeds the preset number, the method for halting the communication network handover may control the mobile communication terminal not to conduct cell reselection with respect to the first communication network. In exemplary embodiments, when the detected number of reception times exceeds a preset number in operation 240, a timer set to expire when a maintenance time of communications with the second network exceeds a timer threshold can be utilized to recheck availability of communications with the first communication network, for example, as shown in FIG. 7. Other methods to initialize the detected number of reception times so that communications can be reestablished with the first network upon its availability are described, for example, in exemplary embodiments of FIG. 4 and FIG. 6 discussed below.

The method for halting the communication network handover may retrieve a cell of which an electric field is higher than a predetermined threshold among a plurality of cells with respect to the first communication network in operation 260, and control the mobile communication terminal to be handed over back to the first communication network when a cell of which an electric field is higher than a predetermined threshold is present among the plurality of cells in operation 270.

In exemplary embodiments, the first communication network includes a preferred or higher priority network, and the second communication network includes a lesser preferred or lower priority network. For example, the first network can include a newer generation or faster network, whereas the second network can include a previous generation or slower network.

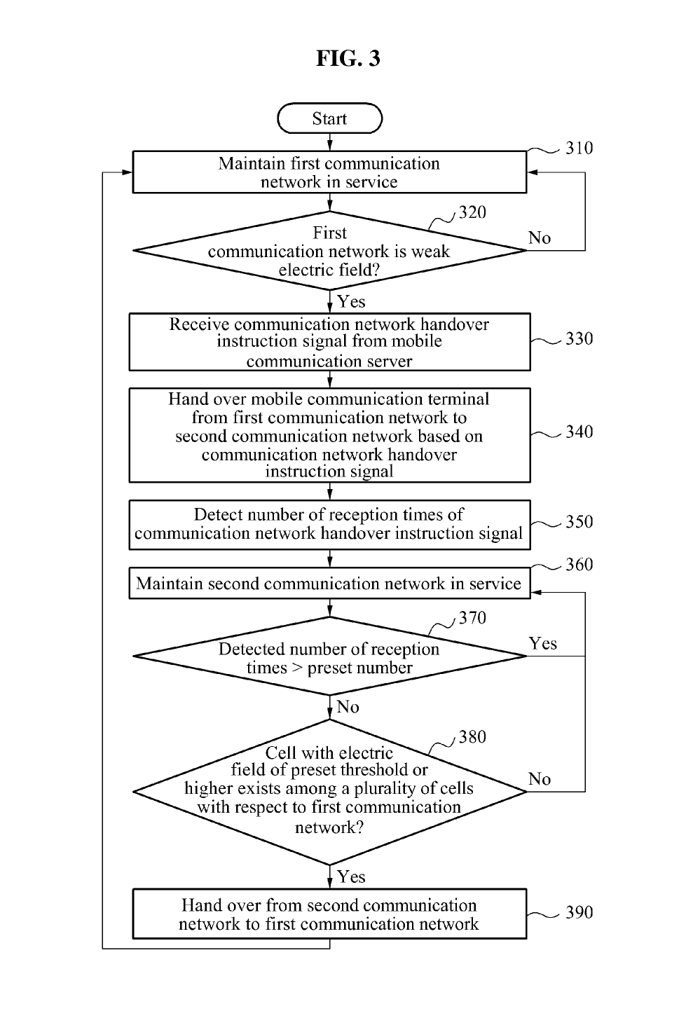

FIG. 3 is a flowchart illustrating a method for halting the communication network handover according to exemplary embodiments of the present invention.

In a method for halting the communication network handover, a mobile terminal may maintain the first communication network in service, and the mobile communication terminal may notify a mobile communication network of an electric field with respect to the first communication network in operation 310.

The method for halting the communication network handover may determine whether the first communication network is a weak electric field in operation 320, and the mobile communication terminal may transmit an indication if the electric field of the first communication network to the mobile communication network. The mobile communication network may compare the electric field of the first communication network with a threshold to determine whether the first communication network is a weak electric field and to determine whether to hand over the mobile communication terminal to the second communication network. After the determination, the first communication network may transmit a communication network handover instruction signal, such as, a handover instruction or a redirection instruction, to the mobile communication terminal.

The method for halting the communication network handover may receive a communication network handover instruction signal from the mobile communication network in operation 330, hand over the mobile communication terminal from the first communication network to the second communication network according to the communication network handover instruction signal in operation 340, and detect a number of reception times of the communication network handover instruction signal in operation 350. The detecting can increment a counter that tracks a number of reception times of a communication network handover instruction signal.

For example, the mobile communication terminal may be handed over from the LTE network to the WCDMA network based on the received communication network handover instruction signal. According to operation 340, the mobile communication terminal may maintain the second communication network in service in operation 360 where the number of reception times of the communication network handover instruction signal is less than a threshold, and may continue to receive a communication service through the WCDMA network.

The method for halting the communication network handover may examine the number of reception times of the communication network handover instruction signal detected in operation 350 and determine whether the detected number of reception times exceeds a preset number or threshold in operation 370. In exemplary embodiments, when the detected number of reception times exceeds a preset number in operation 370, a timer set to expire when a maintenance time of communications with the second network exceeds a timer threshold can in utilized to recheck availability of communications with the first communication network, for example, as shown in FIG. 7. Other methods to initialize the detected number of reception times so that communications can be reestablished with the first network upon its availability are described, for example, in exemplary embodiments of FIG. 4 and FIG. 6 discussed below.

When the number of reception times exceeds the preset number, the method for halting the communication network handover may prevent the mobile communication terminal not to be handed over to the first communication network. For example, the apparatus for preventing or halting the communication network handover may change a condition such that the mobile communication terminal does not conduct cell reselection, and thus the mobile communication terminal may continue to receive a communication service through the second communication network.

Further, when the number of reception times is the preset number or lower, the method for halting the communication network handover may control the mobile communication terminal to conduct the cell reselection again. Here, the method for halting the communication network handover may determine whether there is a cell having an electric field of a preset threshold or higher among a plurality of cells with respect to the first communication network in operation 380, and control the mobile communication terminal to be handed over back to the first communication network when there is a cell having an electric field of the preset threshold or higher. For example, the method for halting the communication network handover may control the mobile communication terminal to conduct the cell reselection again when there is a cell having an electric field of the preset threshold or higher among the plurality of cells with respect to the first communication network in operation 390.

Here, when a cell of which an electric field is higher than a predetermined threshold is present among a plurality of cells with respect to the LTE network, the mobile communication terminal attempts to be connected to the LTE network. When a cell of which an electric field is higher than a predetermined threshold is absent, the mobile communication terminal may maintain the WCDMA network. Further, the method for halting the communication network handover may attempt to register a location of the mobile communication terminal when the mobile communication terminal is handed over to the LTE network.

FIG. 4 is a flowchart illustrating a method of canceling an operation of halting a communication network handover according to exemplary embodiments of the present invention.

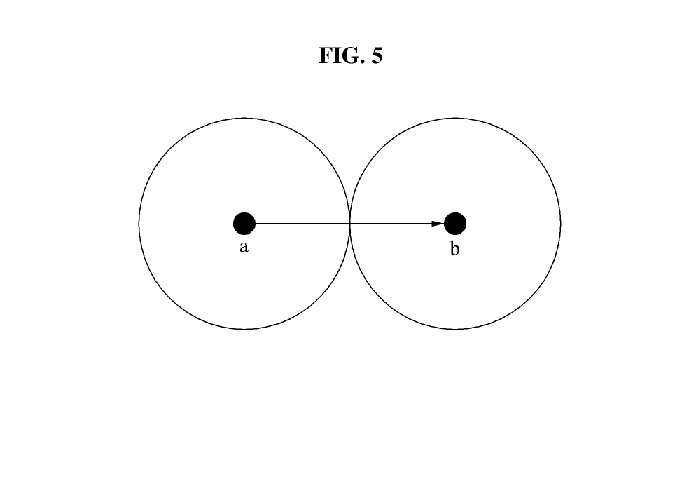

A method for halting the communication network handover may control the mobile communication terminal to maintain the second communication network in service in operation 410, and monitor whether a location of the mobile communication terminal is changed so that a cell with respect to the first communication network is changed in operations 420 and 430. An example of changing a location of the mobile communication terminal is shown in FIG. 5.

FIG. 5 illustrates changing a cell of a mobile communication network of a mobile communication terminal according to exemplary embodiments of the present invention.

For example, the method for halting the communication network handover may monitor whether the mobile communication terminal is moved by the user from a position a to a position b, as shown in FIG. 5, while receiving a communication service through the WCDMA network.

Referring back to FIG. 4, when the cell with respect to the first communication network is changed in operation 430, the method for halting the communication network handover may initialize a number of reception times of a communication network handover instruction signal in operation 440, control the mobile communication terminal to be handed over back to the first communication network, and retrieve a cell having an electric field of a preset threshold or higher with respect to the first communication network in operation 450.

When a cell with an electric field higher than a threshold is present with respect to the first communication network, the method for halting the communication network handover may control the mobile communication terminal to be handed over from the second communication network to the first communication network in operation 460. When a cell with an electric field higher than a threshold is absent with respect to the first communication network, the method for halting the communication network handover may control the mobile communication terminal to maintain the second communication network in operation 470.

For example, when the cell is not changed, the mobile communication terminal may continue receiving a communication service through the WCDMA network. Further, when the cell is changed, the mobile communication terminal may be handed over back to the LTE network. The mobile communication terminal may either conduct cell reselection in an idle state, attempt to be connected to the LTE network in the presence of a cell of the LTE network, or maintain the WCDMA network in the absence of a cell of the LTE network. The method for halting the communication network handover may register a location of the mobile communication terminal when the mobile communication terminal is handed over to the LTE network.

FIG. 6 is a flowchart illustrating a method of canceling an operation of halting a communication network handover according to exemplary embodiments of the present invention.

The method for halting the communication network handover may control the mobile communication terminal to maintain the second communication network in service in operation 610, and monitor an electric field with respect to the first communication network in operations 620 and 630. For example, the mobile communication terminal may periodically detect an electric field with respect to the LTE network while receiving a communication service through the WCDMA network.

When the electric field with respect to the first communication network exceeds a preset threshold, the method for halting the communication network handover may initialize a number of reception times of a communication network handover instruction signal in operation 640, control the mobile communication terminal to be handed over back to the first communication network, and retrieve a cell with an electric field higher than a threshold with respect to the first communication network in operation 650.

Here, the threshold, which is obtained from experimental values, may denote an electric field which is higher than a reference value for a handover or redirection depending on a communication network so as not to cause a handover or redirection.

When a cell with an electric field higher than a threshold is present with respect to the first communication network, the method for halting the communication network handover may control the mobile communication terminal to be handed over from the second communication network to the first communication network in operation 660. When a cell with an electric field higher than a threshold is absent with respect to the first communication network, the method for halting the communication network handover may control the mobile communication terminal to maintain the second communication network in operation 670.

For example, when an electric field with respect to the LTE network is less than a threshold, the mobile communication terminal may continue receiving a communication service through the WCDMA network. However, when the electric field with respect to the LTE network exceeds the threshold, the mobile communication terminal may be handed over back to the LTE network. The mobile communication terminal may conduct cell reselection in an idle state, attempt to be connected to the LTE network in the presence of a cell of the LTE network, or maintain the WCDMA network in the absence of a cell of the LTE network. Here, the method for halting the communication network handover may register a location of the mobile communication terminal when the mobile communication terminal is handed over to the LTE network.

FIG. 7 is a flowchart illustrating a method of canceling an operation of halting a communication network handover according to exemplary embodiments of the present invention

Referring to FIG. 7, the method for halting the communication network handover may control the mobile communication terminal to maintain the second communication network in service in operation 710 and record a period of time from a time to start controlling the mobile communication terminal so as not to hand over the mobile communication terminal to the first communication network to a current time as a maintenance time of the second communication network in operations 720 and 730. For example, the method for halting the communication network handover may record a period of time during which the mobile communication terminal is controlled so as not to conduct cell reselection with respect to the LTE network while receiving a communication service through the WDCMA network.

When the maintenance time of the second communication network terminates, the method for halting the communication network handover may initialize a number of reception times of a communication network handover instruction in operation 740, control the mobile communication terminal to be handed over back to the first communication network, and retrieve a cell having an electric field of a preset threshold or higher with respect to the first communication network in operation 750.

When there is a cell having an electric field higher than a threshold with respect to the first communication network, the method for halting the communication network handover may control the mobile communication terminal to be handed over from the second communication network to the first communication network in operation 760. When there is no cell having an electric field higher than threshold with respect to the first communication network, the method for halting the communication network handover may control the mobile communication terminal to maintain the second communication network in operation 770.

For example, the mobile communication terminal may continue receiving a communication service through the WCDMA network for a designated time, and then the mobile communication terminal may be handed over back to the LTE network after the designated time. The mobile communication terminal may conduct cell reselection in an idle state, attempt to be connected to the LTE network in the presence of a cell of the LTE network, or maintain the WCDMA network in the absence of a cell of the LTE network. Here, the method for halting the communication network handover may register a location of the mobile communication terminal when the mobile communication terminal is handed over to the LTE network.

According to exemplary embodiments of the present invention, a looping of a handover of a communication network may be prevented.

According to exemplary embodiments of the present invention, looping of a handover of a communication network may be prevented, thereby reducing consumption of a battery of a mobile communication terminal.

According to exemplary embodiments of the present invention, a mobile communication terminal may be more stably provided with a communication service.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling handover of a mobile communication terminal, the method comprising:
communicating with a first communication network;
receiving a communication network handover instruction to handover communications from the first communication network to a second communication network;
communicating with the second communication network;
detecting a number of reception times of the communication network handover instruction; and
halting the handover from the second communication network to the first communication network when the detected number of reception times exceeds a threshold.

2. The method of claim 1, wherein communications using the first communication network is preferred over using the second communication network.

3. The method of claim 1, further comprising:
handing over communications from the second communication network to the first communication network, when the detected number of reception times is less than the threshold and an electric field of the first communication network is greater than an electric field threshold.

4. The method of claim 1, further comprising:
detecting a cell of the first communication network with an electric field; and
handing over the communications to the first communication network when the electric field is greater than an electric field threshold.

5. The method of claim 1, further comprising:
initializing the number of reception times, when a maintenance time of communications with the second network exceeds a timer threshold.

6. The method of claim 1, wherein the first communication network and the second communication network use different communication technologies.

7. The method of claim 1, further comprising:
initializing the number of reception times, when a maintenance time of communications with the second network exceeds a timer threshold,
wherein communications using the first communication network is preferred over using the second communication network, and the first communication network and the second communication network use different communication technologies.

8. The method of claim 1, further comprising initializing the number of reception times, when a change in a cell of the first communications network is detected.

9. The method of claim 1, wherein the first communication network comprises a Long Term Evolution (LTE) network, and the second communication network comprises a Wideband Code Division Multiple Access (WCDMA) network.

10. A mobile communication terminal to control handover between networks, the terminal comprising:
a transceiver configured to communicate with a first communication network and a second communication network;
a reception unit configured to receive from the first communication network an communication network handover instruction to handover communications from the first communication network to the second communication network;
a detection unit configured to detect a number of reception times of the communication network handover instruction; and
a control unit configured to halt the handover from the second communication network to ii the first communication network, when the detected number of reception times exceeds a threshold and the terminal is communicating over the second communication network.

11. The terminal of claim 10, wherein communications using the first communication network is preferred over using the second communication network.

12. The terminal of claim 10, wherein the control unit is further configured to hand over communications from the second communication network to the first communication network, when the detected number of reception times is less than the threshold and an electric field of the first communication network is greater than an electric field threshold.

13. The terminal of claim 10, wherein the control unit is further configured to detect a cell of the first communication network with an electric field, and hand over the communications to the first communication network, when the electric field is greater than an electric field threshold and the terminal is communicating with the second communication network.

14. The terminal of claim 10, wherein the control unit is further configured to initialize the number of reception times, when a maintenance time of communications with the second network exceeds a timer threshold and the terminal is communicating with the second communication network.

15. The terminal of claim 10, wherein the first communication network and the second communication network use different communication technologies.

16. The terminal of claim 10, wherein the control unit is further configured to initialize the number of reception times, when a maintenance time of communications with the second network exceeds a timer threshold and the terminal is communicating with the second communication network,
wherein communications using the first communication network is preferred over using the second communication network, and the first communication network and the second communication network use different communication technologies.

17. The terminal of claim 10, wherein the control unit is configured to initialize the number of reception times, when a change in a cell of the first communications network is detected.

18. The terminal of claim 10, wherein the first communication network comprises a Long Term Evolution (LTE) network, and the second communication network comprises a Wideband Code Division Multiple Access (WCDMA) network.

19. A non-transitory readable storage that, when executed by an imaging apparatus including one or more processors, causes the one or more processors to hand over communications of a mobile communication terminal, the operations comprising:
communicating with a first communication network;
receiving a communication network handover instruction to handover communications from the first communication network to a second communication network;
communicating with the second communication network;
detecting a number of reception times of the communication network handover instruction; and
halting the handover from the second communication network to the first communication network when the detected number of reception times exceeds a threshold.
